(19) United States
(12) Patent Application Publication
(10) Pub. No.: US 2020/0202659 A1
(43) Pub. Date: Jun. 25, 2020

(54) VENDING MACHINE

(71) Applicant: Edward Chen, Shanghai (CN)

(72) Inventor: Edward Chen, Shanghai (CN)

(21) Appl. No.: 16/568,389

(22) Filed: Sep. 12, 2019

(30) Foreign Application Priority Data
Dec. 21, 2018 (CN) 201822165913.5

(51) Int. Cl. G07F 11/72; G05B 15/02; G07F 11/16; F25D 11/04; H05B 6/80

(52) U.S. Cl. CPC G07F 11/72; G05B 15/02; H05B 6/808; F25D 11/04; G07F 11/16

(57) ABSTRACT

A vending machine that automatically heats frozen foods, to provide customers with rapidly heated food. The vending machine has separate freezing and heating units, which are highly effective for their respective functions and yet sufficiently insulated from each other so as not to affect the quality of the food. In addition, the vending machine has a mechanism to transmit the food from the freezing to the heating unit for rapid heating, and to a pickup unit for the customer to pickup the food.

### TECHNICAL FIELD

The invention relates to the technical field of vending machines, in particular to a vending machine capable of freezing food and fast heating.

### TECHNICAL BACKGROUND

Vending machines, also known as vending machines, and 24-hour micro-unmanned supermarkets, are common equipment for commercial automation. Vending machines are not limited by time or place, saving manpower and facilitating transactions. Common vending machines currently include beverage vending machines, food vending machines, integrated vending machines, cosmetic vending machines, and the like.

The existing vending machine with freezing function has a freezing temperature of mostly above zero, a short storage time of food, and a short replenishment period, and for foods, especially meat-like foods, it needs to be stored at −18 ° C. or less to obtain a longer length preservation period. The existing vending machine with heating function generally sets the heating unit and the freezing unit into one body (that is, the same area). When a certain food is sold, the food is heated in the heating unit in the same area. The heat generated by such heating causes temperature fluctuations in the freezing zone and affects the safe storage period of the food. In addition, if the meat-based foods are kept below −18 ° C., the food cannot be quickly heated to a suitable human eating temperature in a short time using the existing conventional heating method, and the food selling speed is low, which is not conducive to the fast food of the vending machine sales.

Therefore, in the prior art, there are few vending machines for selling meat snacks such as hamburgers and pizzas, and in particular, vending machines for foods having a freezing temperature of −18 ° C. or lower.

### SUMMARY

In order to satisfy the user's use of the vending machine to purchase such food, the invention is designed to separately set the freezing unit of the food and the heating unit, not only to ensure that the temperature of the food storage area is not affected, but also to automatically sell the food for rapid heating. The invention can also be used in cargo aircraft.

The present invention has been made to solve the above technical problems, and an object thereof is to provide a vending machine. The vending machine of the utility model separates the freezing unit of the food from the heating unit, and uses the conveying mechanism to transfer the food in the freezing zone to the heating zone, and then rapidly heats the food, thereby accelerating the production speed of the food and the selling speed, which is beneficial to the food. The vending machine carries out food sales.

Specifically, the present invention provides a vending machine, including a vending machine body, wherein the vending machine body is provided with: A control unit that controls an action of the vending machine; A freezing unit that stores food and freezes the stored food; A heating unit that receives the food and heats the received food, and the heating unit and the freezing unit are thermally isolated by using an isolation module; A transport unit configured to transfer food from the freezing unit to the heating unit; a picking unit that takes and takes out food from the vending machine body; and wherein the freezing unit, the heating unit, the conveying unit, and the picking unit are all in communication connection with the control unit.

Compared with the prior art, the vending machine provided by the utility model can prevent the heating of the heating unit from affecting the temperature fluctuation of the freezing unit area by setting the freezing and heating of the food in the same area, thereby improving the safe storage period of the food. The isolation module can thermally isolate the freezing unit from the heating unit, reduce heat transfer between the two, and improve the freezing capacity of the freezing unit, thereby improving the safe storage period of the food.

Further, preferably, the freezing unit includes a freezing chamber and a compressor, and the compressor compresses the refrigerant to control the temperature in the freezing chamber to −18 ° C. or lower. According to this preferred embodiment, the temperature of the freezing chamber is controlled to −18 ° C. or lower by the compressor, and microorganisms can be effectively suppressed to maintain the nutrition of the food.

Further, preferably, an ozone sterilization module is further disposed in the freezing unit. According to the preferred embodiment, the food in the freezing unit is sterilized and disinfected by using ozone to ensure the safety of the food. Ozone sterilization, sterilization is rapid and efficient, and the oxides produced during the sterilization process are non-toxic and tasteless, and will not cause secondary pollution.

Additionally, preferably, the heating unit includes a closed heating chamber, a magnetron for heating, and a cooling module for magnetron cooling. According to this preferred embodiment, the microwave is generated by the magnetron, and the food located in the heater is heated to shorten the heating time. Further, preferably, there are two magnetrons, and the two magnetrons are disposed at the top and the bottom of the heating chamber. According to this preferred embodiment, the two magnetrons disposed above and below enable the temperature in the heating chamber to rise rapidly, thereby enabling rapid heating of the food in the heating chamber.

Further, preferably, the cooling module is an air cooling module or a water cooling module. According to the preferred embodiment, the specific heat capacity of the water is high, and more heat can be absorbed. The water cooling can quickly and effectively cool the magnetron, and the cooling efficiency is high.

Further, preferably, the transport unit includes a transport stage, a first drive mechanism, and a first push mechanism configured to be capable of receiving food, the first drive mechanism being configured to be capable of driving the transfer of the transfer station, and the first pushing mechanism is configured to be capable of pushing food on the transfer table into the heating unit.

According to the preferred embodiment, the food is taken up by the transfer table, and the food is pushed into the heating unit by the first pushing mechanism. The food on the transfer table is only supported by the gravity and the conveying table, and the food is not affected by the external force. No deformation occurs to keep the shape of the food intact and beautiful.

Further, preferably, the vending machine further includes a payment unit including a button for food selection and/or an operation screen for displaying food information for selecting a food, the payment unit further including a cash collection port and/or electronic scan code payment code.

According to the preferred solution, the food can be selected by using a button or an operation screen, and the payment can be completed by means of cash or electronic payment. The selection and payment methods of the food are various and simple, and are convenient for the user to purchase.

In addition, preferably, the picking unit includes a second pushing mechanism and a picking port, the picking port is adjacent to the heating unit, and the second pushing mechanism is configured to be capable of pushing the food in the heating unit the pick-up port.

According to the preferred solution, the pick-up port is arranged close to the heating unit, which facilitates pushing the heated food to the pick-up port, simplifies the work of the second push mechanism, and speeds up the food delivery efficiency.

In addition, preferably, the control unit is further connected to a remote monitoring unit by using a communication module, and the communication module sends the information collected by the control unit to the remote monitoring unit, and the remote monitoring unit is controlled by a background system. The vending machine information is collected, monitored and controlled.

According to the preferred solution, by setting a remote monitoring unit, the remote collection, monitoring and control of the vending machine is realized through the background system, and the intelligent operation of the computer system is maximized, the automation and efficiency of the management are improved, and the monitoring cost is reduced.

### DRAWINGS

FIG. 1 is a schematic overall view of an embodiment of the present invention;

FIG. 2 is a schematic structural view of a horizontal cross section of an embodiment of the present invention.

### DESCRIPTION OF THE REFERENCE SIGNS

100, vending machine main body; 101, light box; 102, advertising screen; 103, cargo lane; 104, first conveyor belt; 1, control unit; 2, freezing unit; 21, freezing chamber; 22, compressor; Module; 3, heating unit; 31, heating chamber; 32, magnetron; 4, conveying unit; 41, transport table; 42, first drive mechanism; 43, first push mechanism; 44, second conveyor; Payment unit; 51, operation screen; 52, cash collection port; 6, pick-up unit; 61, pick-up port; 62, second push mechanism; 7, isolation module; 8, remote monitoring unit; 9, communication module.

### DETAILED DESCRIPTION

The present invention will be further described in detail below with reference to the accompanying drawings. The structure and the like of the vending machine are schematically simplified in the drawing.

In the description of the present invention, it is to be understood that the terms “upper”, “lower”, “front”, “back”, “left”, “right”, “top”, “bottom”, “inner^{”}, the orientation or positional relationship of the “outside” or the like is based on the orientation or positional relationship shown in the drawings, and is merely for the convenience of describing the present invention and the simplified description, and does not indicate or imply that the device or component referred to has a specific orientation. It is constructed and operated in a specific orientation and is therefore not to be construed as limiting the invention.

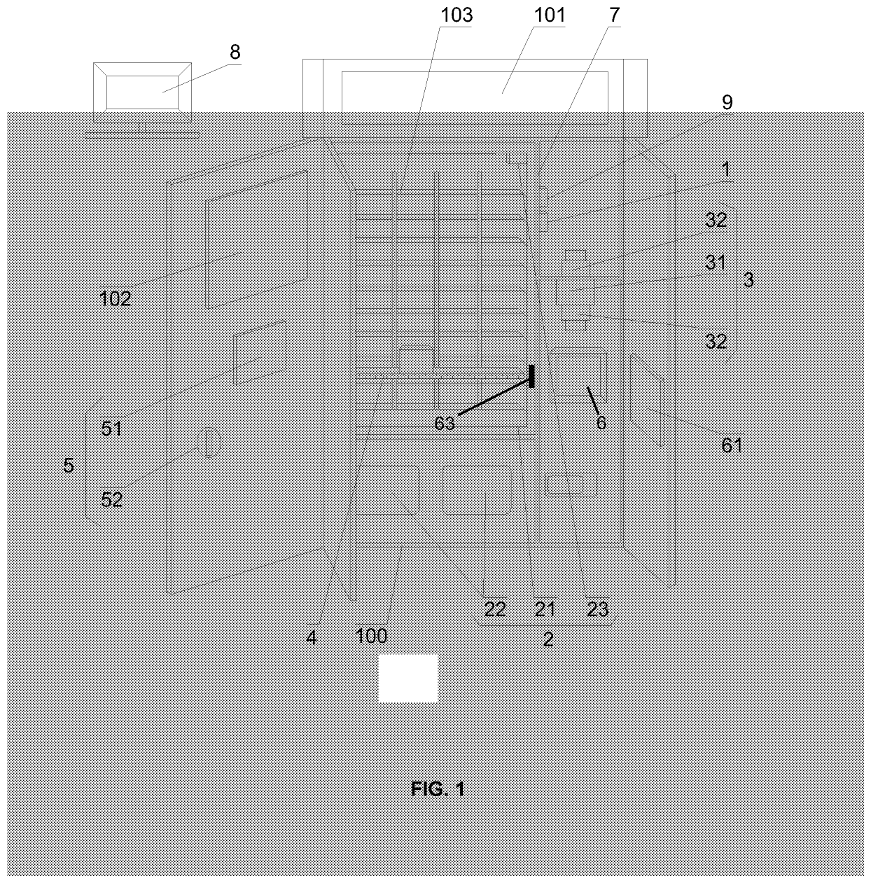

Embodiments of the present invention provide a vending machine, as shown in FIG. 1, including a vending machine body 100 having a light box 101 and an advertising screen 102 for illumination and advertising. The kiosk main body 100 is provided with a control unit 1, a freezing unit 2, a heating unit 3, a conveying unit 4, a payment unit 5, and a pickup unit 6. Wherein, the control unit 1 can control the operation of the vending machine; the freezing unit 2 can store the food and freeze the stored food; the heating unit 3 can receive the food and heat the received food; and the conveying unit 4 can transfer the food from the freezing unit 2 to the heating unit 3; the payment unit 5 is capable of the user selecting the food and paying; the picking unit 6 is capable of taking and taking out the food from the vending machine main body 100. The heating unit 3 and the freezing unit 2 are thermally isolated by the isolation module 7, and in particular, the isolation module 7 is a polyurethane insulation panel. The freezing unit 2, the heating unit 3, the conveying unit 4, the payment unit 5, and the pickup unit 6 are all in communication connection with the control unit 1.

Compared with the prior art, the vending machine provided by the present invention can prevent the temperature fluctuation of the freezing unit 2 from affecting the temperature fluctuation of the heating unit 3 by setting the freezing and heating isolation of the food and separately, thereby improving the food's safe storage period. The isolation module 7 can thermally isolate the freezing unit 2 from the heating unit 3, reduce heat transfer between the two, improve the freezing capacity of the freezing unit 2, and thereby improve the safe storage period of the food. Referring to FIG. 1, the freezing unit 2 includes a freezing chamber 21 and a compressor 22 that compresses refrigerant to control the temperature in the freezing chamber 21 to −18 ° C. or lower. The freezing unit 2 also includes a condenser, an evaporator, an air deflector, etc., which are common devices in compression refrigeration, which are not shown in the drawings for the sake of simplicity. The temperature of the freezing chamber 21 is controlled to −18 ° C. or below, and the original quality of the food is preserved at a low temperature such that, for example, water, juice, etc. in the food tissue are not lost, and microorganisms are effectively inhibited without any preservatives and additives. At the same time, the food nutrition is preserved to the utmost extent, and the food has the advantages of deliciousness, convenience, health, hygiene, nutrition and benefits, and the food is safe.

Referring to FIG. 1, an ozone sterilization module 23 is further disposed in the freezing unit 2 to sterilize and disinfect the food in the freezing unit 2 by using ozone to ensure the safety of the food. Ozone sterilization is rapid and efficient, and the oxides produced during the sterilization process are non-toxic and tasteless, and will not cause secondary pollution. Referring to FIG. 1, the heating unit 3 includes a closed heating chamber 31, a magnetron 32 for heating, and a cooling module for cooling the magnetron 32 (The structure and operation of a cooling module for magnetron cooling are well-known to those of ordinary skill in the art, and for the sake of simplicity, not shown in the figure). There are two magnetrons 32, which are disposed at upper and lower positions of the heating chamber 31. Microwaves can be generated by the magnetron 32 to microwave the food located in the heater.

Specifically, there are two magnetrons 32, and two magnetrons 32 are disposed at the top and bottom of the heating chamber 31. The two magnetrons 32 disposed above and below enable the temperature inside the heating chamber 31 to rise rapidly, so that the food in the heating chamber 31 can be quickly heated. The heating unit 3 has the advantages of uniform heating, high speed, selective heating, strong heat penetration capability, etc., which can shorten the heating time, improve the food manufacturing efficiency, and improve the product quality.

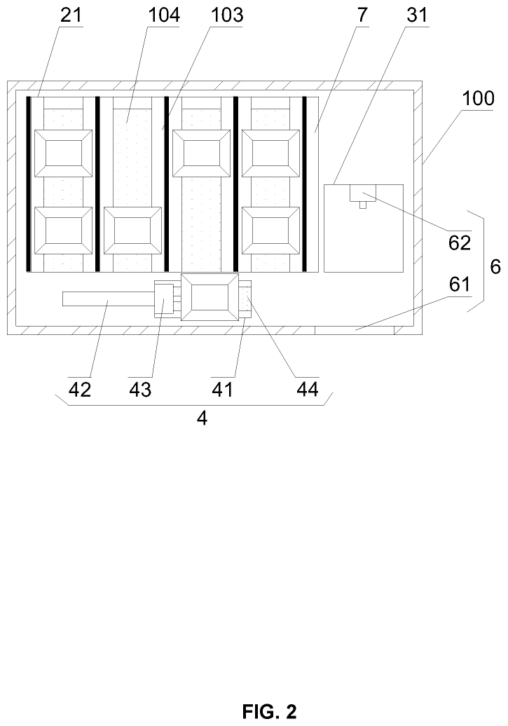

Water has a higher specific heat capacity and can absorb more heat. Therefore, the cooling module is provided as a water-cooling module, and the magnetron 32 is quickly and effectively cooled by water cooling, and the cooling efficiency is high. In other embodiments, the cooling module can also be an air cooled module or any other module that can effect cooling of the magnetron 32. Referring to FIG. 2, the freezing unit 2 also has a plurality of cargo lanes 103, each of which is capable of receiving a plurality of food items. The receiving surface of the cargo lane 103 is provided with a first conveyor belt 104. When it is necessary to purchase the food at a certain cargo lane 103, the first conveyor belt 104 operates to transport the food product toward the opening of the cargo lane 103 until the food product near the opening falls onto the conveying unit 4.

As shown in FIGS. 1 and 2, the conveying unit 4 includes a transport table 41, a first drive mechanism 42 and a first push mechanism 43, the transport table 41 is capable of receiving food, and the first drive mechanism 42 is configured to be capable of driving the position of the transport table 41. In the transfer, the first pushing mechanism 43 can push the food on the transfer table 41 through door 63 into the pickup unit 6, which is capable of lifting the food vertically into heating unit 3. The food is taken up by the transport table 41, and when the food is pushed into the heating unit 3 by the first pushing mechanism 43, the food on the transport table 41 is only subjected to the gravity and the support force given by the transport table 41, and the food is not affected by the external force. No deformation occurs to keep the shape of the food intact and beautiful. The first pushing mechanism 43 may be a linear motor, a cylinder assembly or a screw assembly, or the like.

The first driving mechanism 42 is a two-axis linkage mechanism, and the first driving mechanism 42 can drive the up and down and left and right movements of the transport table 41. The receiving surface of the transport table 41 is provided with a second conveyor belt 44. When the transport table 41 is moved to the heating unit 3, the second conveyor belt 44 operates to transport the food toward the heating unit 3, reducing the force of the first pushing mechanism 43 that was pushing the food to protect the shape of the food.

Referring to FIG. 1, in the present embodiment, the payment unit 5 includes an operation screen 51 and a cash collection port 52. The operation panel 51 can display the type, price, and the like of the food. The user can select the product on the operation screen 51 and select the product. The cash is then paid through the cash collection port 52, or the payment code is generated on the operation screen 51, and electronic payment is performed using an electronic device such as a mobile phone. In other embodiments, the payment unit 5 may also include a button and a scan code payment code, the user selects the food through the button, and scans the code for electronic payment. Of course, the operation screen 51 may be combined with the scan code payment code, the cash collection port 52 may be combined with the button, or only the operation panel 51 or the like may be provided as long as the selection and payment of the food can be realized. The food can be selected by using the button or the operation screen 51, and the payment can be completed by cash or electronic payment. The selection and payment method of the food is simple and diverse, and is convenient for the user to purchase.

As shown in FIG. 1 and FIG. 2, the pickup unit 6 includes a pick-up port 61, and the pick-up port 61 is adjacent to the heating unit 3, so as to facilitate pushing the heated food to the pick-up port 61, simplifying the work of the second pushing mechanism 62 to speed up the efficiency of food shipments. The pickup unit 6 further includes a second pushing mechanism 62 capable of pushing the food to the pickup port 61. The second pushing mechanism 62 may be a linear motor, a cylinder assembly or a screw assembly, or the like.

Referring to FIG. 1, the control unit 1 is also communicably connected with a remote monitoring unit 8 by using a communication module 9, and the communication module 9 transmits the information by the control unit 1 to the remote monitoring unit 8, and the remote monitoring unit 8 is controlled by a background system, such as a computer system implemented on one or more host servers each of which having their own system memory, processors and communications interface. The remote monitoring unit 8 works remotely through the background system to monitor and control the vending machine. The communication module 9 may be a modem, a wired or wireless network interface (e.g. an Ethernet card), a communications port, etc. . . . By setting up the remote monitoring unit 8, the remote collection, monitoring and control of the vending machine can be realized through the background system, and the intelligent operation of the control unit computer system can be maximized to improve the automation and efficiency of the management and reduce the monitoring cost. The communication module 9 can also be used for interactive communication between the cloud management platform and a computer application, and the operator can remotely collect the sales information, monitor the device status, and control the operation or stop of the vending machine through the background system.

For those skilled in the art, the steps of the above control method can be deleted or sequentially adjusted as needed within the scope of the technical idea of the present invention. Those skilled in the art will appreciate that in the various embodiments described above, numerous technical details are set forth to provide the reader with a better understanding of the present application. However, even without these technical details and various changes and modifications based on the above embodiments, the technical solutions claimed in the claims of the present application can be substantially realized. Therefore, various changes in the above-described embodiments may be made in the form and details without departing from the spirit and scope of the invention.

1. A vending machine, which comprises
A vending machine body;
A control unit that controls an action of the vending machine;
A freezing unit that stores food and freezes the stored food;
A heating unit receives the stored food and heats the received food, and the heating unit and the freezing unit are thermally isolated by using an isolation module;
A conveying unit configured to transfer stored food from the freezing unit to the heating unit; and
A pickup unit that takes out stored or heated food from the vending machine body;
And wherein the freezing unit, the heating unit, the conveying unit, and the pickup unit are all in communication connection with the control unit.

2. The vending machine according to claim 1, wherein the freezing unit includes a freezing chamber and a compressor, and the compressor compresses a refrigerant to control the temperature in the freezing chamber to −18 ° C. or lower.

3. The vending machine according to claim 2, wherein an ozone sterilization module is further disposed in the freezing unit.

4. The vending machine of claim 1 wherein said heating unit comprises a closed heating chamber, a magnetron for heating, and a cooling module for magnetron cooling.

5. According to the vending machine mentioned in claim 4, the magnetron has two magnetrons, and the two magnetrons are respectively located at the top and bottom of the heating chamber.

6. The vending machine according to claim 4, wherein the cooling module is an air cooling module or a water cooling module.

7. The vending machine according to claim 1, wherein the conveying unit comprises a transport table, a first driving mechanism, and a first pushing mechanism, the transport table being configured to be capable of receiving stored food, the first drive mechanism is configured to be capable of driving a positional shift of the transport table, and the first push mechanism is configured to be capable of pushing stored food on the transport table into the heating unit.

8. The vending machine according to claim 2, wherein the conveying unit comprises a transport table, a first driving mechanism, and a first pushing mechanism, the transport table being configured to be capable of receiving stored food, the first drive mechanism is configured to be capable of driving a positional shift of the transport table, and the first push mechanism is configured to be capable of pushing stored food on the transport table into the heating unit.

9. The vending machine according to claim 3, wherein the conveying unit comprises a transport table, a first driving mechanism, and a first pushing mechanism, the transport table being configured to be capable of receiving stored food, the first drive mechanism is configured to be capable of driving a positional shift of the transport table, and the first push mechanism is configured to be capable of pushing stored food on the transport table into the heating unit.

10. The vending machine according to claim 4, wherein the conveying unit comprises a transport table, a first driving mechanism, and a first pushing mechanism, the transport table being configured to be capable of receiving stored food, the first drive mechanism is configured to be capable of driving a positional shift of the transport table, and the first push mechanism is configured to be capable of pushing stored food on the transport table into the heating unit.

11. The vending machine according to claim 5, wherein the conveying unit comprises a transport table, a first driving mechanism, and a first pushing mechanism, the transport table being configured to be capable of receiving stored food, the first drive mechanism is configured to be capable of driving a positional shift of the transport table, and the first push mechanism is configured to be capable of pushing stored food on the transport table into the heating unit.

12. The vending machine according to claim 6, wherein the conveying unit comprises a transport table, a first driving mechanism, and a first pushing mechanism, the transport table being configured to be capable of receiving stored food, the first drive mechanism is configured to be capable of driving a positional shift of the transport table, and the first push mechanism is configured to be capable of pushing stored food on the transport table into the heating unit.

13. The vending machine mentioned in claim 1 is characterized in that the vending machine also includes a payment unit, which includes a button for food selection and/or an operation screen for displaying food information for food selection, and the payment unit also includes a cash receiving port and/or an electronic scanning payment code.

14. The vending machine according to claim 1, wherein the pickup unit includes a second pushing mechanism and a pick-up port, the pick-up port is adjacent to the heating unit, and the second pushing mechanism is configured to be capable of pushing the heated food in the heating unit to the pick-up port.

15. The vending machine according to claim 1, wherein the control unit is further communicably connected to a remote monitoring unit by means of a communication module, and information from the control unit is communicated to the remote monitoring unit, which remotely monitors, and controls the vending machine through a background system.

16. The vending machine according to claim 2, wherein the control unit is further communicably connected to a remote monitoring unit by means of a communication module, and information from the control unit is communicated to the remote monitoring unit, which remotely monitors, and controls the vending machine through a background system.

17. The vending machine according to claim 3, wherein the control unit is further communicably connected to a remote monitoring unit by means of a communication module, and information from the control unit is communicated to the remote monitoring unit, which remotely monitors, and controls the vending machine through a background system.

18. The vending machine according to claim 4, wherein the control unit is further communicably connected to a remote monitoring unit by means of a communication module, and information from the control unit is communicated to the remote monitoring unit, which remotely monitors, and controls the vending machine through a background system.

19. The vending machine according to claim 5, wherein the control unit is further communicably connected to a remote monitoring unit by means of a communication module, and information from the control unit is communicated to the remote monitoring unit, which remotely monitors, and controls the vending machine through a background system.

20. The vending machine according to claim 13, wherein the control unit is further communicably connected to a remote monitoring unit by means of a communication module, and information from the control unit is communicated to the remote monitoring unit, which remotely monitors, and controls the vending machine through a background system.

21. The vending machine according to claim 14, wherein the control unit is further communicably connected to a remote monitoring unit by means of a communication module, and information from the control unit is communicated to the remote monitoring unit, which remotely monitors, and controls the vending machine through a background system.
